(19) United States
(12) Patent Application Publication
(10) Pub. No.: US 2026/0038308 A1
(43) Pub. Date: Feb. 5, 2026

(54) System and Method for Intelligent Toll Validation

(71) Applicant: CDM Smith Inc., Boston, MA (US)

(72) Inventors: Zubair F. Ghafoor, Downers Grove, IL (US); Kenneth Allen Deitiker, Fentress, TX (US); Helen Barton, Egg Harbor Township, NJ (US); Melayne Furer, Aventura, FL (US); Snehal Sameer Ambare, Winter Garden, FL (US)

(21) Appl. No.: 19/286,888

(22) Filed: Jul. 31, 2025

Related U.S. Application Data
(60) Provisional application No. 63/678,338, filed on Aug. 1, 2024.

(51) Int. Cl. G07B 15/06; G06V 10/20; G06V 10/764; G08G 1/017

(52) U.S. Cl. CPC G07B 15/06; G06V 10/255; G06V 10/764; G08G 1/0175

(57) ABSTRACT

Embodiments provide intelligent toll validation. One such embodiment, using a computer vision model, based on video data associated with a vehicle, determines a first type instance of the vehicle and a first axle count of the vehicle. A toll transaction record associated with the vehicle is identified. The toll transaction record includes a second type instance of the vehicle and a second axle count of the vehicle. A synchronization status is determined based on the determined first type instance of the vehicle, the second type instance of the vehicle, the determined first axle count of the vehicle, and the second axle count of the vehicle. Responsive to the determined synchronization status being positive, the identified toll transaction record is validated.

### RELATED APPLICATION

This application claims the benefit of U.S. Provisional Application No. 63/678,338, filed on Aug. 1, 2024. The entire teachings of the above application are incorporated herein by reference.

### BACKGROUND

Toll agencies are required to periodically ensure that the field equipment they have installed at toll plazas is functioning adequately.

### SUMMARY

Traditional methods of toll equipment audit involve manual review of the toll transaction data and comparison against a very small sample of field data obtained from the same equipment that generated the transaction data. This also creates a certain level of redundancy in the audit process. As such, functionality with improved accuracy and efficiency is needed. Embodiments provide such functionality.

An example embodiment is directed to a computer-based system for intelligent toll validation. The computer-based system includes a computer vision model (which may include, e.g., multiple computer vision models), at least one processor, and a memory with computer code instructions stored thereon. The computer vision model may be an artificial intelligence (AI) or machine learning (ML) model specifically designed to interpret and analyze visual information—such as images or video—in a way that mimics or supports human vision. The at least one processor and the memory, with the computer code instructions, are configured to cause the computer-based system to, using the computer vision model, based on video data associated with a vehicle, determine a first type instance of the vehicle and a first axle count of the vehicle. The at least one processor and the memory, with the computer code instructions, are further configured to cause the computer-based system to identify a toll transaction record associated with the vehicle. The toll transaction record includes a second type instance of the vehicle and a second axle count of the vehicle. The at least one processor and the memory, with the computer code instructions, are further configured to cause the computer-based system to determine a synchronization status based on the determined first type instance of the vehicle, the second type instance of the vehicle, the determined first axle count of the vehicle, and the second axle count of the vehicle. The at least one processor and the memory, with the computer code instructions, are further configured to cause the computer-based system to, responsive to the determined synchronization status being positive, validate the identified toll transaction record.

In another example embodiment, the at least one processor and the memory, with the computer code instructions, may be further configured to cause the computer-based system to, responsive to the determined synchronization status being negative, using the computer vision model, based on the video data, determine a revised type of the vehicle.

According to yet another example embodiment, the computer vision model may be configured to determine the first type instance of the vehicle and the first axle count of the vehicle based on a shape of the vehicle.

In an example embodiment, the at least one processor and the memory, with the computer code instructions, may be further configured to cause the computer-based system to, using the computer vision model, based on the video data, detect the vehicle.

According to another example embodiment, the at least one processor and the memory, with the computer code instructions, may be further configured to cause the computer-based system to, using the computer vision model, based on the video data, track the vehicle. In yet another example embodiment, the at least one processor and the memory, with the computer code instructions, may be further configured to cause the computer-based system to, using the computer vision model, based on the video data, assign a tracking identifier (ID) to the vehicle.

In an example embodiment, the determined first type instance of the vehicle may be a car type, a truck type, or a bus type. According to another example embodiment, the determined first type instance of the vehicle may be the truck type, and the determined first axle count of the vehicle may be two, three, four, five, six, seven, or greater than seven.

According to an example embodiment, the at least one processor and the memory, with the computer code instructions, may be further configured to cause the computer-based system to, using the computer vision model, based on the video data, determine a unit type of the vehicle. In another example embodiment, the determined unit type includes a trailer count.

In an example embodiment, each of the determined first type instance of the vehicle and the second type instance of the vehicle may be a Federal Highway Administration (FHWA) vehicle category classification.

According to another example embodiment, the at least one processor and the memory, with the computer code instructions, may be further configured to cause the computer-based system to, using the computer vision model, based on the video data, determine a body style of the vehicle.

In yet another example embodiment, the at least one processor and the memory, with the computer code instructions, may be further configured to cause the computer-based system to store the validated toll transaction record in a database.

According to an example embodiment, the at least one processor and the memory, with the computer code instructions, may be further configured to cause the computer-based system to, using the computer vision model, based on the video data, determine that the vehicle is stopped or a direction of travel of the vehicle.

In another example embodiment, the at least one processor and the memory, with the computer code instructions, may be further configured to cause the computer-based system to, using the computer vision model, based on the video data, determine at least one of a lane change count of the vehicle and a lane change frequency of the vehicle.

According to yet another example embodiment, the at least one processor and the memory, with the computer code instructions, may be further configured to cause the computer-based system to, using the computer vision model, based on the video data, determine a traffic congestion status.

In an example embodiment, the at least one processor and the memory, with the computer code instructions, may be further configured to cause the computer-based system to, using the computer vision model, based on the video data, identify a presence of at least one of a non-vehicle transportation device and a pedestrian.

According to another example embodiment, the at least one processor and the memory, with the computer code instructions, may be further configured to cause the computer-based system to, using the computer vision model, based on the video data, determine whether the vehicle is located in a predefined area.

In yet another example embodiment, the vehicle may be travelling in a lane at a first time point. The toll transaction record may further include a second time point and a second ID of the lane. The at least one processor and the memory, with the computer code instructions, may be further configured to cause the computer-based system to identify the toll transaction record based on the first time point, a first ID of the lane, the second time point, and the second ID of the lane.

Another example embodiment is directed to a computer-implemented method for intelligent toll validation. In such an embodiment, the method is configured to implement any embodiments, or combination of embodiments, described herein.

Yet another example embodiment is directed to a non-transitory computer program product for intelligent toll validation. The computer program product includes a computer-readable medium with computer code instructions stored thereon. The computer code instructions are configured, when executed by at least one processor, to cause the at least one processor to implement any embodiments, or combination of embodiments, described herein.

It is noted that embodiments of the computer-based system, computer-implemented method, and non-transitory computer program product may be configured to implement any embodiments, or combination of embodiments, described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example embodiment of a computer-based system.

FIG. 2 is an example chart of relative monthly revenue impact.

FIG. 3 is an example table showing potential down class loss and potential detection loss.

FIG. 4 is an example image of independent audit camera placement according to an embodiment.

FIG. 5 is a block diagram of an example machine learning (ML)/artificial intelligence (AI) model vehicle detection and classification process according to an embodiment.

FIG. 6 is a block diagram of an example ML/AI-based toll audit process according to an embodiment.

FIG. 7 is an example user interface according to an embodiment.

FIG. 8 is a block diagram of an example ML/AI system architecture according to an embodiment.

FIG. 9 is a block diagram of an example model output video annotation process according to an embodiment.

FIG. 10 is an example image of an annotated video frame according to an embodiment.

FIG. 11 is a flowchart of a method for intelligent toll validation according to an example embodiment.

FIG. 12 is a block diagram of an example embodiment of an internal structure of a computer in which various embodiments of the present disclosure may be implemented.

### DETAILED DESCRIPTION

A description of example embodiments follows.

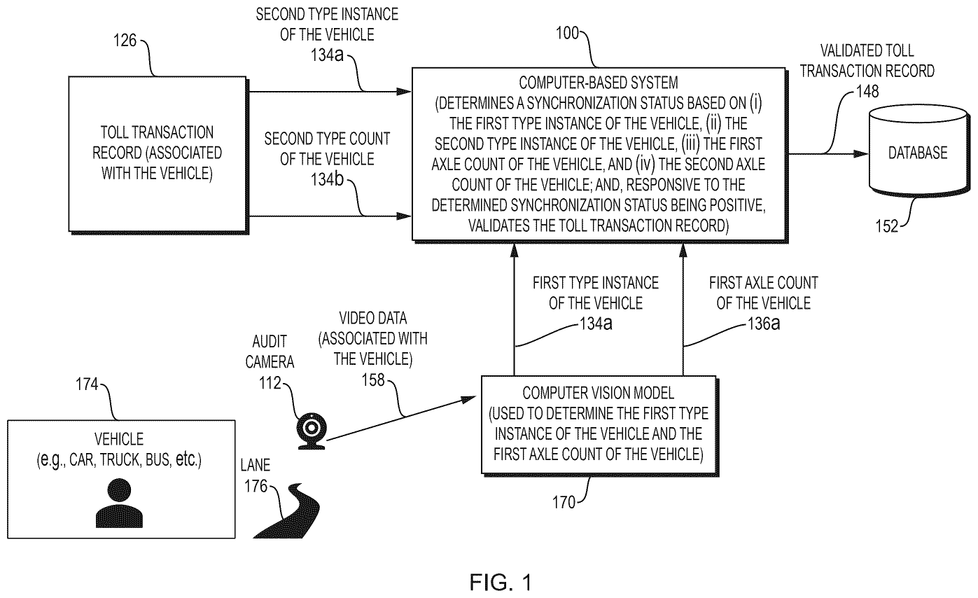

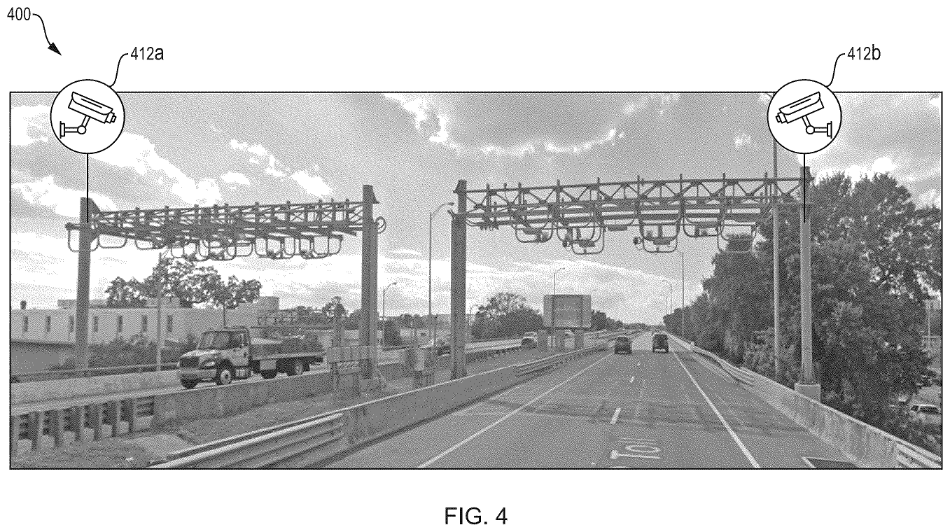

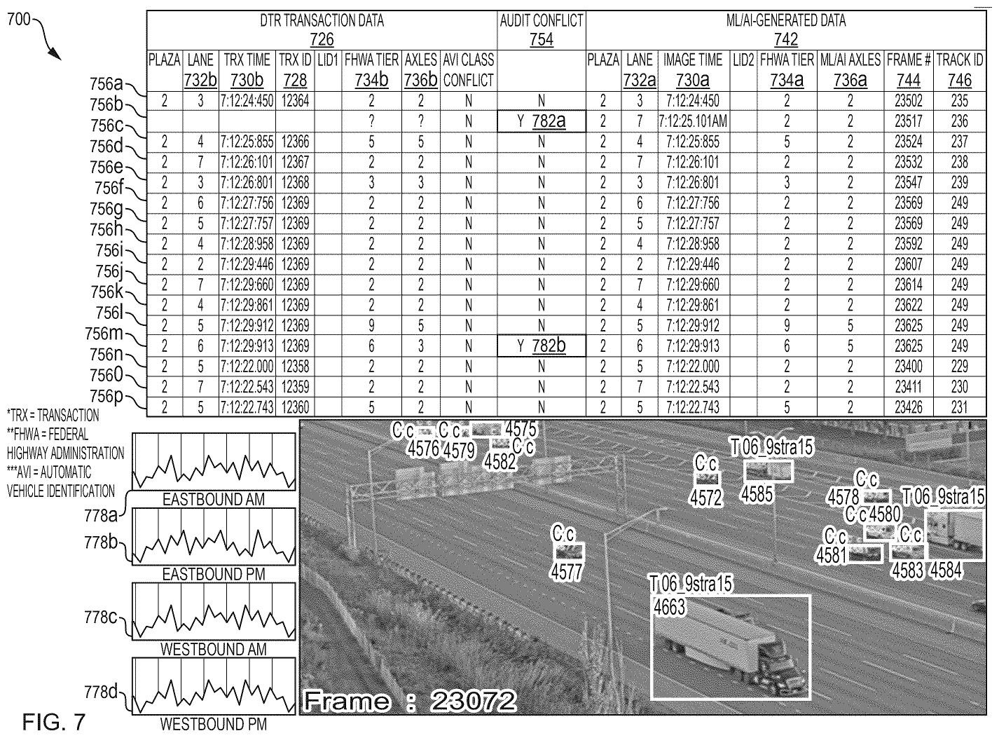

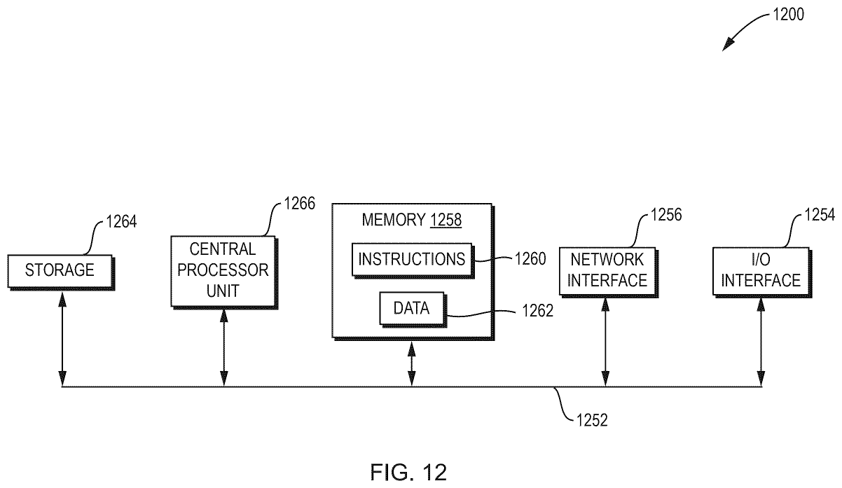

FIG. 1 is a block diagram of an example embodiment of a computer-based system 100. In the example embodiment of FIG. 1, the system 100 comprises a computer vision model 170. The system 100 further comprises at least one processor (not shown) and memory (not shown) with computer code instructions (not shown) stored thereon, such as disclosed further below in relation to FIG. 12. In an embodiment, the computer vision model 170 may be trained with different types of data (not shown). According to another embodiment, the model 170 may be a neural network-based computer vision model. Continuing with reference to FIG. 1, the at least one processor and the memory, with the computer code instructions, may be configured to cause the system 100 to, using the computer vision model 170, based on video data 158 associated with a vehicle 174, determine a first type instance 134a of the vehicle 174 and a first axle count 136a of the vehicle 174. The video data 158 may be obtained from, e.g., audit camera 112 or audit camera(s) 412a and/or 412b (FIG. 4). To continue, the at least one processor and the memory, with the computer code instructions, may be further configured to cause the system 100 to identify a toll transaction record 126 associated with the vehicle 174. The toll transaction record 174 may include a second type instance 134b of the vehicle 174 and a second axle count 136b of the vehicle 174. The at least one processor and the memory, with the computer code instructions, may be further configured to cause the system 100 to determine a synchronization status (e.g., 754 (FIG. 7)) based on the determined first type instance 134a of the vehicle 174, the second type instance 134b of the vehicle 174, the determined first axle count 136a of the vehicle 174, and the second axle count 136b of the vehicle 174. The at least one processor and the memory, with the computer code instructions, may be further configured to cause the system 100 to, responsive to the determined synchronization status being positive, validate the identified toll transaction record 126.

In another example embodiment, the at least one processor and the memory, with the computer code instructions, may be further configured to cause the system 100 to, responsive to the determined synchronization status being negative, using the computer vision model 170, based on the video data 158, determine a revised type (not shown) of the vehicle 174. For example, in an embodiment, if a discrepancy exists between the second type instance 134b of the vehicle 174 present in the toll transaction record 126 and the first type instance 134a of the vehicle 174 initially determined by the computer vision model 170, a further attempt at classifying the vehicle 174 may be performed using the computer vision model 170. Additionally or alternatively, in an embodiment, the existence of a discrepancy may trigger a further review process, e.g., a review of specific video frame(s) (not shown) of the video data 158.

According to yet another example embodiment of the system 100, the computer vision model 170 may be configured to determine the first type instance 134a of the vehicle 174 and the first axle count 134b of the vehicle 174 based on a shape (not shown) of the vehicle 174.

In an example embodiment, the at least one processor and the memory, with the computer code instructions, may be further configured to cause the system 100 to, using the computer vision model 170, based on the video data 158, detect the vehicle 174.

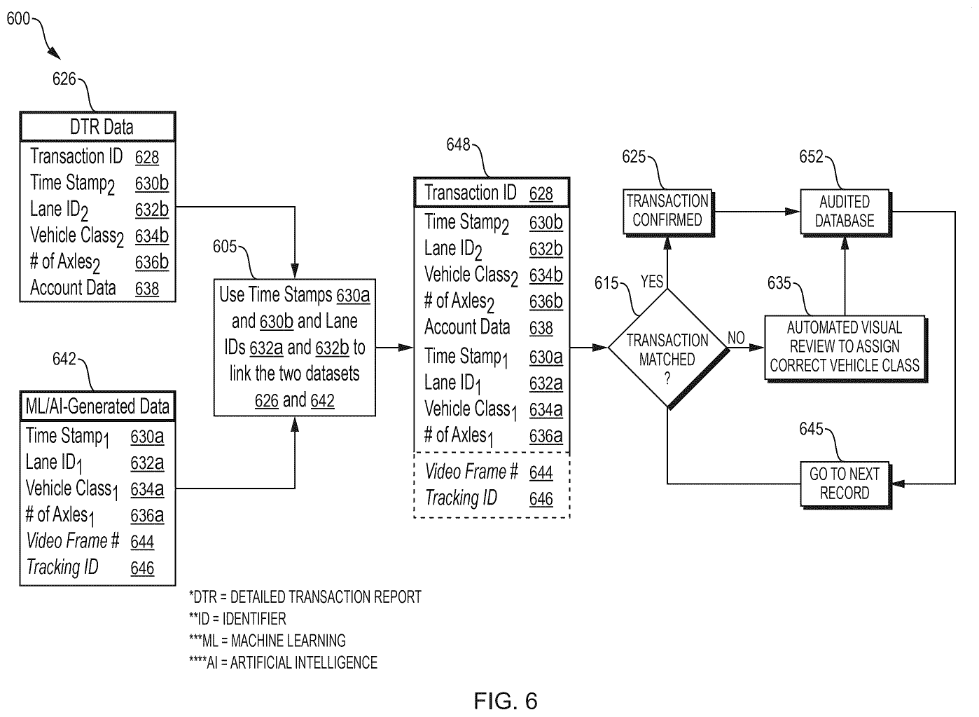

According to another example embodiment, the at least one processor and the memory, with the computer code instructions, may be further configured to cause the system 100 to, using the computer vision model 170, based on the video data 158, track the vehicle 174. In yet another example embodiment, the at least one processor and the memory, with the computer code instructions, may be further configured to cause the system 100 to, using the computer vision model 170, based on the video data 158, assign a tracking identifier (ID) (e.g., 646 (FIG. 6) or 746 (FIG. 7)) to the vehicle 174.

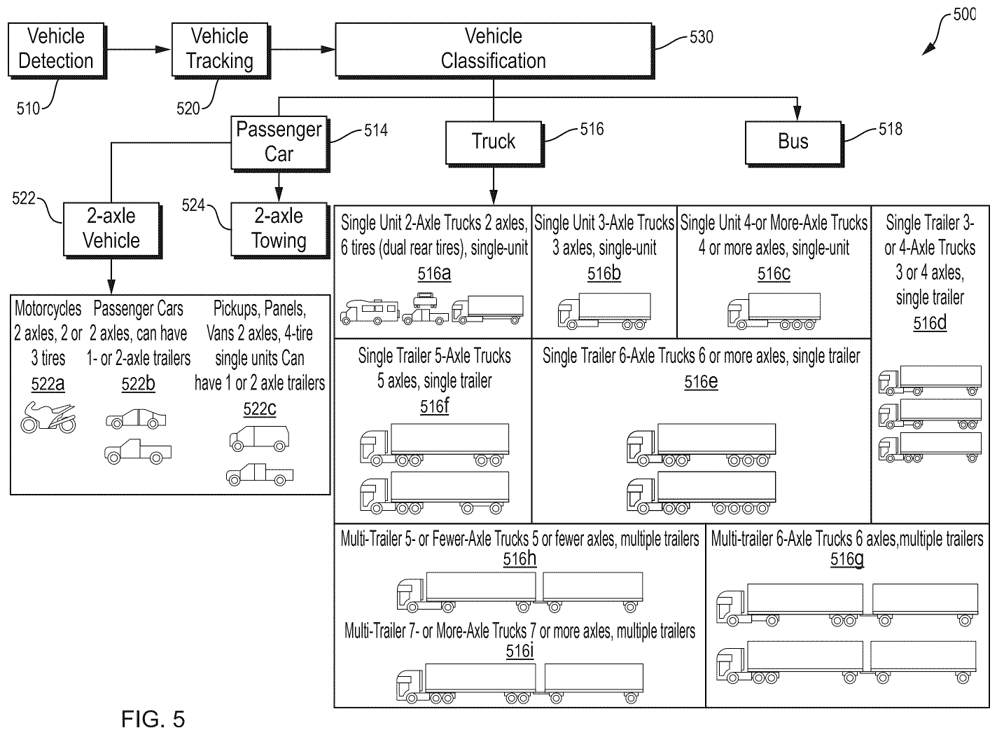

In an example embodiment of the system 100, the determined first type instance 134a of the vehicle may be a car type (e.g., 514 (FIG. 5)), a truck type (e.g., 516 (FIG. 5)), or a bus type (e.g., 518 (FIG. 5)). According to another example embodiment of the system 100, the determined first type instance 134a of the vehicle 174 may be the truck type 516, and the determined first axle count 136a of the vehicle 174 may be two (e.g., 516a (FIG. 5)), three (e.g., 516b or 516d (FIG. 5)), four (e.g., 516c or 516d (FIG. 5)), five (e.g., 516f or 516h (FIG. 5)), six (e.g., 516e or 516g (FIG. 5)), seven (e.g., 516c, 516g, or 516i (FIG. 5)), or greater than seven (e.g., 516c, 516g, or 516i).

According to an example embodiment, the at least one processor and the memory, with the computer code instructions, may be further configured to cause the system 100 to, using the computer vision model 170, based on the video data 158, determine a unit type (not shown), e.g., single-unit truck without or with trailer, truck tractor without or with one or more trailers, etc., of the vehicle 174. In another example embodiment of the system 100, the determined unit type includes a trailer count (not shown).

In an example embodiment of the system 100, each of the determined first type instance 134a of the vehicle 174 and the second type instance 134b of the vehicle 174 may be a Federal Highway Administration (FHWA) vehicle category classification (e.g., 514, 516, 516a-516i, 518, 522, 522a-522c, or 524 (FIG. 5)).

According to another example embodiment, the at least one processor and the memory, with the computer code instructions, may be further configured to cause the system 100 to, using the computer vision model 174, based on the video data 158, determine a body style (not shown), e.g., a special-purpose crane or a truck/trailer having a large number of axles (such as 10 or more), etc., of the vehicle 174.

In yet another example embodiment, the at least one processor and the memory, with the computer code instructions, may be further configured to cause the system 100 to store the validated toll transaction record 148 in a database 152.

According to an example embodiment, the at least one processor and the memory, with the computer code instructions, may be further configured to cause the system 100 to, using the computer vision model 170, based on the video data 158, determine that the vehicle 174 is stopped (not shown) or a direction of travel (not shown) of the vehicle 174.

In another example embodiment, the at least one processor and the memory, with the computer code instructions, may be further configured to cause the system 100 to, using the computer vision model 170, based on the video data 158, determine at least one of a lane change count (not shown) of the vehicle 174 and a lane change frequency (not shown) of the vehicle 174.

According to yet another example embodiment, the at least one processor and the memory, with the computer code instructions, may be further configured to cause the system 100 to, using the computer vision model 170, based on the video data 174, determine a traffic congestion status (e.g., 778a-778d (FIG. 7)), which may be measured in terms of number of vehicles per hour per lane.

In an example embodiment, the at least one processor and the memory, with the computer code instructions, may be further configured to cause the system 100 to, using the computer vision model 174, based on the video data 158, identify a presence (not shown) of at least one of a non-vehicle transportation device and a pedestrian.

According to another example embodiment, the at least one processor and the memory, with the computer code instructions, may be further configured to cause the system 100 to, using the computer vision model 170, based on the video data 158, determine whether the vehicle 174 is located in a predefined area (not shown).

In yet another example embodiment of the system 100, the vehicle 174 may be travelling in a lane 176 at a first time point (e.g., 630a (FIG. 6)). The toll transaction record 126 may further include a second time point (e.g., 630b (FIG. 6)) and a second ID (e.g., 632b (FIG. 6)) of the lane 176. The at least one processor and the memory, with the computer code instructions, may be further configured to cause the system 100 to identify the toll transaction record 126 based on the first time point 630a, a first ID (e.g., 632a (FIG. 6)) of the lane 176, the second time point 630b, and the second ID 632b of the lane 176.

### INTRODUCTION

Toll agencies are required to periodically ensure that the field equipment they have installed at toll plazas is functioning adequately. An adequate operation entails correct identification of vehicles and thus correct toll rate be charged to that corresponding account. In most cases, the toll rate is based on the number of axles of a vehicle and the number of axles is generally determined by the pavement-embedded hardware and other sensors installed in the toll plaza. This equipment requires periodic calibration and if not calibrated, may not detect the correct vehicle types.

Traditional methods of toll equipment audit involve manual review of the toll transaction data and comparison against a very small sample of field data obtained from the same equipment that generated the transactions data. This creates a certain level of redundancy in the audit process. In some other cases, a small number of known vehicles were provided devices so they can be detected by toll equipment to establish the validity of toll equipment operations.

### Overview of Existing Lane Audit Practices

Examples of traditional lane audit types include vendor audits, agency internal audits, and external audits.

Vendor audits may be performed by vendor staff. A key performance indicator (KPI) compliance audit performed by a vendor may include sampling transactions according to various audit criteria. The audit criteria may be defined during audit process design, and may include items such as sample size and sample diversity in terms of various times of day, etc.

Agency internal audits may be performed by toll authority staff. KPI verification performed by an agency may include reviewing KPI reports to verify their accuracy. A toll authority may perform snap or unscheduled audits, which are typically utilized for informational purposes and/or trend analysis.

External audits may be performed by a third-party auditor. Third-party external audits are typically performed for a toll agency and may have a requirement to enforce contract compliance. Moreover, external audits can vary greatly in duration and/or cost. External audits are frequently used to verify performance requirements for System Acceptance Testing (SAT), which refers to the final phase of testing before a system is approved for deployment or use.

Overall, traditional lane audit practices are very labor intensive, costly to perform, and impact revenue streams. With respect to vendor audits, some vendors may also misrepresent the results positively or negatively. Thus, as a minimum best practice, sample audits of vendor KPI audits should be performed. Embodiments address the drawbacks of traditional audit practices and the long-felt need for improved techniques by providing solutions for intelligent toll validation that achieve high levels of independence.

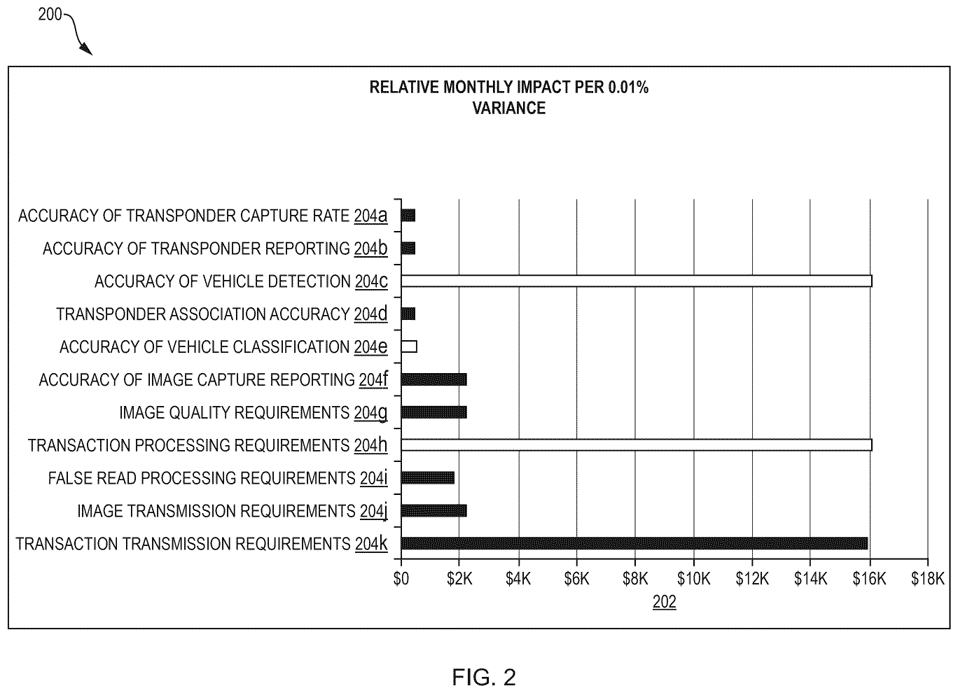

FIG. 2 is an example chart 200 of relative monthly revenue impact 202 per 0.01% variance in KPIs 204a-204j.

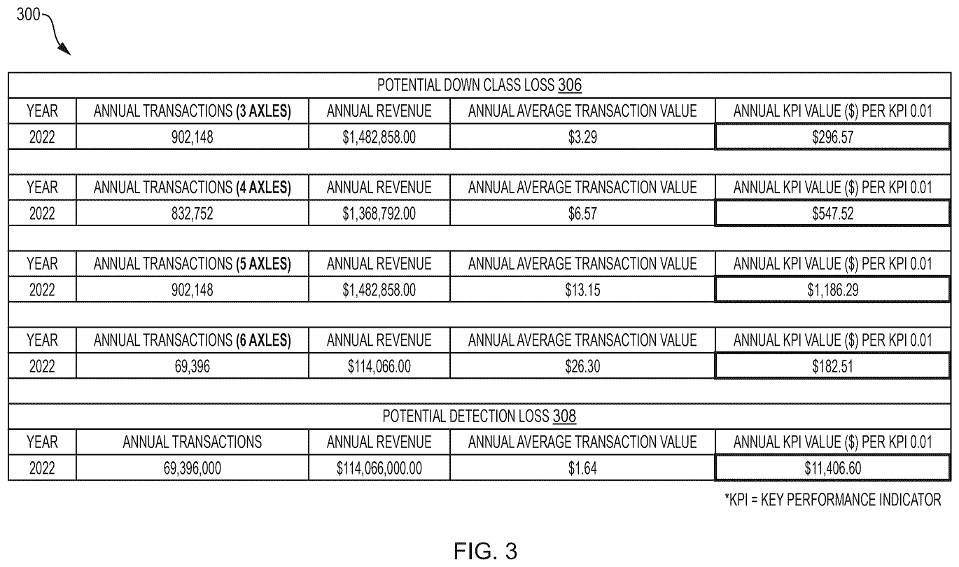

FIG. 3 is an example table 300 showing potential down class loss 306 and potential detection loss 308. Down class loss 306 refers to revenue loss in a situation where a system detects a vehicle as belonging to a lower axle count class. For example, when a vehicle having three axles is identified by a system as a two-axle vehicle. Detection loss 308 refers to revenue loss due to not detecting a vehicle at all.

As shown by the examples of FIGS. 2 and 3, KPI non-compliance may impact revenue and/or expenses.

### Drawbacks of Existing Lane Audit Practices

Traditional approaches to lane auditing suffer from numerous drawbacks. Among these are excessive reliance on integrator/vendor-provided video data and Detailed Transaction Reports (DTRs). This leads to a “fox guarding the henhouse” scenario where source data provided by an integrator or vendor cannot be independently inspected.

Existing approaches are also highly labor intensive. For example, manual review of video streams requires labor-intensive inspection.

Another shortcoming of conventional approaches is the use of so-called “golden lists” to exclude certain types of transactions from toll validation/verification. Using golden list exceptions can have undesirable effects such as excluding anomalous transactions that should be validated or verified. For example, some vehicles may be erroneously considered to be in a golden list, thus causing them to be exempt from tolling.

Traditional approaches can be vulnerable to changes in tolling agency priorities as well. For example, higher priority agency obligations may cause resources to be redirected away from toll audits. Existing toll audits may also require dedicated agency resources, which may be subject to various constraints.

A further drawback of conventional approaches is that data retention design can impact and/or limit the available data sources for toll audits.

Thus, with traditional approaches, constrained resources and/or dependencies on vendor-provided source data may result in an inability to perform independent and necessary toll audit inspections.

In contrast with existing approaches, embodiments leverage the insight that KPI audits are being performed more frequently in the industry, as well as being verified to a higher standard to limit technical “leakage”-which refers to toll evasion by drivers in open road tolling (ORT) settings. Embodiments also provide faster audits, thereby enabling an audit to be performed while a full data set is available. Furthermore, embodiments can utilize larger data sets than conventional approaches, which results in greater accuracy and higher performance.

### Example ML/AI Model-Based Audit Methodology

In an embodiment, by leveraging ML/AI-based computer vision techniques, it is possible to use independently trained model(s) to identify vehicle types in a video and extract the data for each vehicle in terms of time stamp, type of vehicle and corresponding number of axles. Such data can then be correlated against the toll transactions data for the same duration and location. The combined data can then be used to compare the vehicle types in the toll transactions data against the data generated by the ML/AI-based process.

Embodiments provide numerous advantages over legacy methods, including the below non-limiting examples:
a) Availability of a much larger independently collected data set to be compared against transactions data.
b) Significant cost savings by not having to deploy a large number of field crew for data collection.
c) An example methodology can be applied to almost any location where a video is either available or can be recorded from a good vantage point.

Moreover, embodiments supply an example framework that is faster, smarter, larger, and more expandable than existing approaches. An example system of embodiments can be run or operated in the background without human manipulation or intervention.

FIG. 4 is an example image 400 of placement of independent audit cameras 412a and 412b according to an embodiment. In an embodiment, the cameras 412a and 412b may be located near a tolling point, but may be set at an overview position to prevent shadowing and/or enhance the ability for a single video stream to cover multiple lanes. According to another embodiment, the cameras 412a and 412b may be efficient and/or maintain a low profile.

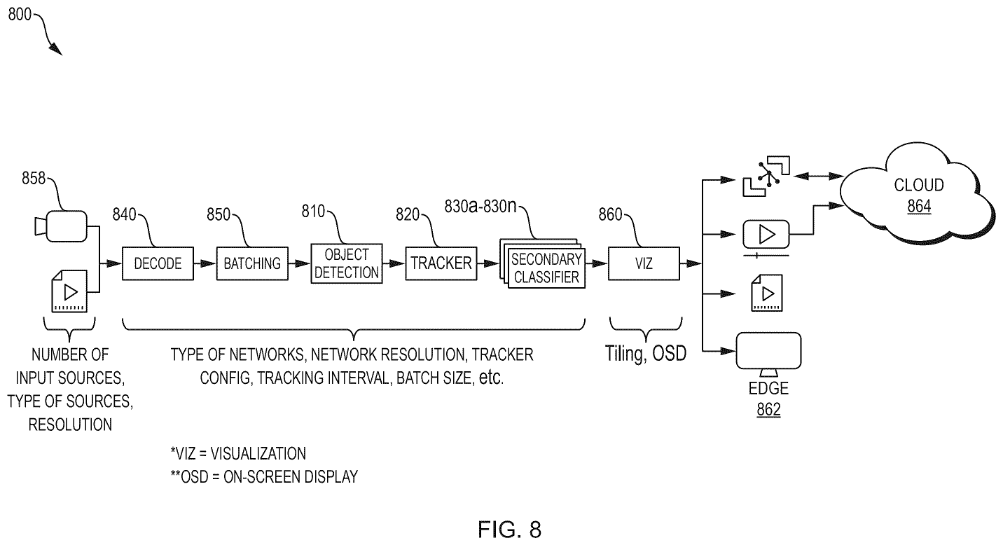

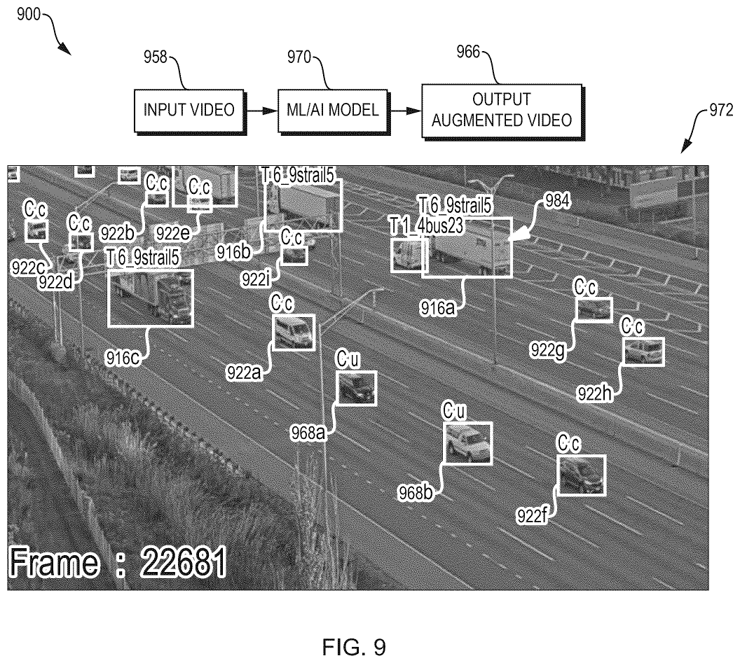

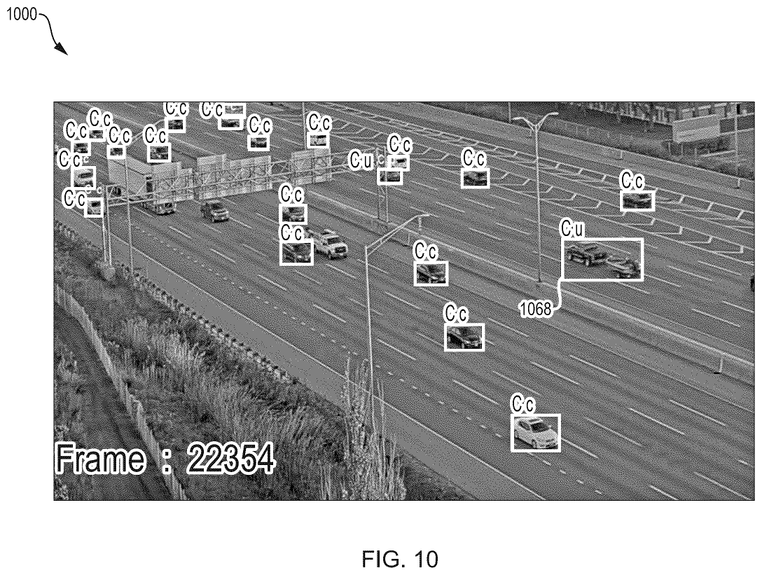

In an embodiment, one or more camera(s) (e.g., 112 (FIG. 1) or 412a-412b) may be procured and installed to capture video data (e.g., 158 (FIG. 1), 858 (FIG. 8), or 958 (FIG. 9)). Having a separate video feed may help avoid reliance on video data from an integrator or vendor. According to another embodiment, the video stream may be of sufficient resolution for ML/AI model(s) to adequately identify vehicles (e.g., 174 (FIG. 1), 916a-916c (FIG. 9), 922a-922i (FIG. 9), 968a-968b (FIG. 9), or 1068 (FIG. 10)).

An example embodiment may obtain access to DTRs (e.g., 126 (FIG. 1), 626 (FIG. 6), or 726 (FIG. 7)). In an embodiment, results may be obtained from performing optical character recognition (OCR) on vehicle license plate images, which images may be available as part of the DTR data and/or from image files that are linked to the DTR data, e.g., via hyperlink or any other suitable means known in the art. Obtaining such OCR results can aid comparison of images for license plates and vehicles, thereby allowing for refinement of OCR techniques and/or fine-tuning of ML/AI models.

Optionally, an embodiment may leverage available information regarding toll rate tables and/or KPIs (e.g., 204a-204j (FIG. 2)) to determine financial impacts (e.g., 202 (FIG. 2), 306 (FIG. 3), or 308 (FIG. 3)), which may be estimates or approximations.

Based on the concepts described herein, an example methodology and a prototype software tool according to an embodiment were developed to facilitate the toll audit process. A custom-trained ML/AI model according to an embodiment was developed that can detect and classify vehicles in a video and write the results of the detection to, e.g., a CSV file. The classification system may utilize the FHWA 13-class system, which is based on the number of axles.

In an embodiment, ML/AI-based computer vision techniques may be applied to correlate transaction data (e.g., 126 (FIG. 1), 626 (FIG. 6), or 726 (FIG. 7)) with independently collected video information (e.g., 642 (FIG. 6) or 742 (FIG. 7)). According to another embodiment, correlation results may be employed for a variety of purposes. For instance, results may be used to perform vehicle classification, which may be according to, e.g., a shape-based system such as the FHWA 13 classification system. In an embodiment, an ML/AI model may be trained based on correlation results and/or vehicle classification results to recognize axles and/or axle configurations. Embodiments provide superior axle recognition performance compared to existing video-only systems that do not utilize correlations with transaction data. In an embodiment, correlation results may be used for verification of transaction transmissions, e.g., verifying results of transaction data using an ML/AI-based process. Further, an example embodiment may employ correlation results to perform time synchronization and/or verification of ML/AI-detected data with DTR data, for instance based on time stamps (e.g., 630a and 630b (FIG. 6) or 730a and 730b (FIG. 7)).

FIG. 5, which illustrates an example classification system, is a block diagram of an example ML/AI model vehicle detection and classification process 500 according to an embodiment. As shown in FIG. 5, the process 500 includes performing vehicle detection 510, the output of which may then be used by vehicle tracking 520. In turn, the output of vehicle tracking 520 may be used to perform vehicle classification 530. The detection 510, tracking 520, and/or classification 530 may be performed using any suitable ML/AI model(s) known to those of skill in the art. To continue, performing vehicle classification 530 results in categorizing a detected 510 and tracked 520 vehicle (not shown) as a passenger car 514, a truck 516, or a bus 518. A passenger car 514 may be further classified as a two-axle vehicle 522 or a two-axle towing configuration 524.

Non-limiting examples of two-axle vehicles 522 may include:
a) motorcycles 522a with two or three tires;
b) passenger cars 522b, optionally having one- or two-axle trailers; and
c) four-tire single unit vehicles 522c such as pickup trucks and vans (e.g., panel vans), optionally having one- or two-axle trailers.

Non-limiting examples of trucks 516 may include:
a) two-axle, six-tire (including, e.g., dual rear tires), single unit trucks 516a;
b) three-axle, single unit trucks 516b;
c) single unit trucks 516c having four or more axles;
d) single trailer trucks 516d having three or four axles;
e) single trailer trucks 516e having six or more axles;
f) five-axle, single trailer trucks 516f;
g) multi-trailer trucks 516g having six or more axles;
h) multi-trailer trucks 516h having five or fewer axles; and
i) multi-trailer trucks 516i having seven or more axles.

FIG. 6, which illustrates an example analytical approach, is a block diagram of an example ML/AI-based toll audit process 600 according to an embodiment.

As shown in FIG. 6, the example analytical process 600 begins at a point when a video (not shown) has been recorded and the corresponding DTR data 626 is also available. The DTR data 626 includes transaction ID 628, time stamp 630b, lane ID 632b, vehicle class 634b, axle count 636b, and account data 638. The video is used to generate ML/AI-based data 642, which includes time stamp 630a, lane ID 632a, vehicle class 634a, axle count 636a, video frame number 644, and tracking ID 646. At step 605, the time stamps 630a and 630b of a vehicle in a specific lane 632a and 632b are used to match the two types of data 626 and 642 and a third consolidated database 648 is generated. This database 648 is then subjected to another automated procedure 615 that checks the vehicle type 634b in DTR 626 against the vehicle type 634a in the ML/AI-generated data 642. In an embodiment, the validation at step 615 may also include a procedure to compare the axle counts 636b and 636a in the DTR 626 and ML/AI-generated 642 data, respectively. If at step 615 the two vehicle types 634a and 634b are the same, then at step 625 the record 648 is considered as being correct, and if they are different, then at step 635 another automated procedure is used to review the data 648 against the corresponding video frame. Upon transaction confirmation 625 or successful completion of the automated procedure 635, the record 648 is stored in an audited database 652 and the matching procedure 615 is performed for a subsequent record (not shown). This example process 600 allows the assignment of correct vehicle type using the ML/AI-generated output video. It should be noted that the process 600 may be repeated for any desired number of DTRs 626, ML/AI-generated datasets 642, and vehicles; the size of the audited database 652 may correspondingly increase over time as additional transactions 648 are validated.

### Example User Interface

The concepts described herein are further illustrated by FIG. 7, which is an example user interface 700 according to an embodiment. As shown in FIG. 7, the interface 700 displays rows 756a-756p with DTR data 726, including columns for transaction ID 728, time stamp 730b, lane ID 732b, vehicle class 734b, and axle count 736b, as well as ML/AI-generated data 742, including columns for time stamp 730a, lane ID 732a, vehicle class 734a, axle count 736a, frame number 744, and tracking ID 746. The interface 700 also displays traffic congestion data 778a-778d. The audit conflict column 754 indicates whether a conflict exists between the DTR data 726 and the ML/AI data 742 for a given row. The rows 756a, 756c-7561, and 756n-756p have no conflict (indicated by ‘N’), whereas the rows 756b and 756m have a conflict (indicated by ‘Y’). For the row 756b, a conflict 782a is present because the corresponding DTR data 726 is missing or unknown, as indicated by blank spaces or ‘?’ entries in the corresponding cells for the columns 728, 730b, 732b, 734b, and 736b. In an embodiment, the DTR data 726 corresponding to the row 756b may be absent due to, e.g., toll evasion. According to another embodiment, blank spaces may indicate that data is missing or unknown, while ‘?’ entries may indicate that a derived data field cannot be generated because required input data is unavailable. For the row 756m, although the corresponding vehicle class values 734a and 734b match, a conflict 782b is nevertheless present because of a mismatch between the corresponding axle count values 736a and 736b. In an embodiment, the existence of the conflicts 782a and/or 782b may prompt a further review process. According to another embodiment, the conflict 782a may have dark shading to indicate that the conflict 782a is caused by missing DTR data 726m, whereas the conflict 782b may have light shading to indicate that the conflict 782b is caused by a discrepancy between the DTR 726 and ML/AI-generated 742 data.

In an embodiment, the interface 700 may be a dashboard. According to another embodiment, the layout and/or design of the interface 700 may be adjusted based on user input.

### Example ML/AI System Architecture

FIG. 8 is a block diagram of an example ML/AI system architecture 800 according to an embodiment. In an embodiment, the architecture 800 may be an end-to-end application that leverages the NVIDIA® DeepStream software development kit (SDK) for streaming analytics. Other known SDKs and frameworks are also suitable. According to another embodiment, the architecture 800 may employ one or more neural network model(s) (not shown). A given model may be configured with a desired network resolution, which may refer to network dimensions of the model in terms of model parameters and/or layers. In an embodiment, a number of model layers may be increased or decreased to achieve a desired balance between model performance and computational resource usage. Continuing with FIG. 8, a decoder 840 may decode one or more input video source(s) 858, which may be of different type(s) (e.g., MP4 or “.mkv” file format) and/or resolution(s) (e.g., high-definition (HD) or Full HD). A batching 850 module may then be invoked to process the decoded 840 video output(s) into batches, e.g., according to a desired or specified batch size. In turn, one or more ML/AI model(s) may perform object detection 810—e.g., vehicle detection and/or primary classification such as between a (passenger) car 514 (FIG. 5), truck 516 (FIG. 5), and bus 518 (FIG. 5), etc.—on the batches 850. According to an embodiment, the model(s) may be trained to detect specific objects in an image. Continuing with FIG. 8, a tracker 820 may be used to track the detected 810 objects. According to an embodiment, the tracker 820 may operate based on a specified configuration and/or tracking interval. For instance, in an embodiment, a tracking interval may refer to a configurable setting that controls whether objects are tracked on each frame or whether, e.g., every other frame or every third frame, can be skipped. Other configuration parameters according to an embodiment may include which tracking technique is used by the tracker 820. In an embodiment, the input video 858 may include successive images (not shown). The same object (e.g., vehicle) may appear in different places within a video frame (not shown) in different images. The tracker 820 may assign a unique ID to an object and follow or “keep track” of the object as it appears in successive images. Continuing with FIG. 8, the tracked 820 objects may then be classified—e.g., among truck types 516a-516i (FIG. 5)—using one or more secondary classifier(s) 830a-830n. In turn, a visualizer (VIZ) 860 may be used to perform on-screen display (OSD) and/or tiling for the classified 830 objects. According to an embodiment, the visualizer 860 may display augmented video. In another embodiment, the visualizer 860 may use tiling for multiple videos being processed concurrently. According to an embodiment, the steps 810, 820, 830a-830n, 840, 850, and/or 860 may optionally be performed by one or more edge server(s) 862. In another embodiment, results generated by the architecture 800, such as metadata, may optionally be transmitted to one or more cloud server(s) 864 for, e.g., reporting and/or post-processing.

### Example ML/AI Model Output Video Annotation

FIG. 9 is a block diagram of an example model output video annotation process 900 according to an embodiment. As shown in FIG. 9, input video data 958 may be processed by ML/AI model 970 to generate augmented output video 966. In an embodiment, the model 970 may perform the following tasks, for non-limiting examples: (1) detecting object(s) of interest within video frames (e.g., 972) of the input video data 958; (2) tracking the object(s) as they appear in successive frames; and (3) assigning bounding boxes (e.g., 984) to the object(s). Continuing with FIG. 9, the image 972 shows an example augmented video frame. In the image 972, normal two-axle passenger vehicles 922a-922i may be indicated with bounding boxes labeled “C c” where ‘c’ is an abbreviation for confirmed. Passenger vehicles 968a and 968b having “undefined” axle configurations (e.g., towing boat, etc.) may be indicated with bounding boxes labeled “C u” where ‘u’ is an abbreviation for undefined. In an embodiment, the undefined vehicles 968a and 968b may require additional review. Single trailer five-axle trucks 916a-916c may be indicated with bounding boxes labeled “T 6_9strail5” where ‘T’ is an abbreviation for truck, 6 is an internal index, 9 is an FHWA class, “strail” is an abbreviation for single trailer, and 5 is the number of axles. According to an embodiment, “mtrail” in a label may be an abbreviation for multiple trailer and “sunit” may be an abbreviation for single unit.

FIG. 10 is an example image 1000 of an annotated video frame according to an embodiment. As shown in FIG. 10, the image 1000 includes vehicle 1068 that is detected and/or classified as having an undefined axle configuration.

### Example ML/AI Model Capabilities

An example trained ML/AI model according to an embodiment provides capabilities including accurate anomaly detection and object classification, as well as an adaptable classification system that determines, e.g., a primary classification of car vs. truck and sub-classifications for trucks with between two and five axles. In an embodiment, anomaly detection may include, for instance, identifying and/or tagging a vehicle moving in the opposite direction or a vehicle that is considered unrecognized by the model. Examples of additional functionality of a trained ML/AI model according to an embodiment include passenger vehicle sub-classification, detecting/identifying and/or classifying vehicles with special body styles, and sub-classifications for trucks with six or more axles. In an embodiment, special vehicle body styles may include rare or unusual vehicles such as special-purpose cranes and trucks or trailers having a large number of axles, e.g., 10 or more axles.

### Example Training and Testing Methodology

An audit process was formulated based on an example ML/AI methodology according to an embodiment. Toll site locations for employing the example ML/AI audit process were determined. The example ML/AI process utilized existing video feeds, e.g., closed-circuit television (CCTV) feeds. Additional features were developed. The example ML/AI process used license plate image and time stamp data to further validate the correlations. Utilizing existing cameras for additional traffic data collection was evaluated.

### Example Features

Embodiments provide numerous features, including the below non-limiting examples:
a) Identification of stopped vehicles;
b) Identification of wrong way vehicles;
c) Detection of pedestrians and bicycles, etc.;
d) Identification of traffic congestion;
e) Detection of excessive lane changes;
f) Lane-based advanced analytics; and
g) Low-profile eco-friendly solutions, e.g., geo-fencing.

### Example Advantages

Embodiments provide numerous advantages, including the below non-limiting examples:
a) Enabling preparation for future reduced infrastructure tolling;
b) Reduced labor and time spent on video-based toll audits, e.g., an estimated ˜75% reduction in labor;
c) Operating in a hardware agnostic manner;
d) Eliminating the need for customer enrollment;
e) Employing larger sample sizes than traditional approaches, thereby improving trend analysis;
f) Leveraging video data source(s) that are independent from vendors' solutions and raw data sources;
g) Delivering a Light Infrastructure Footprint Tolling (LIFT) architecture, which results in a lower level of redundancy;
h) Rapid analysis and reporting of historical performance trends; and
i) Employing separate video source(s) to provide a unique level of redundancy.

### Example Method Embodiment

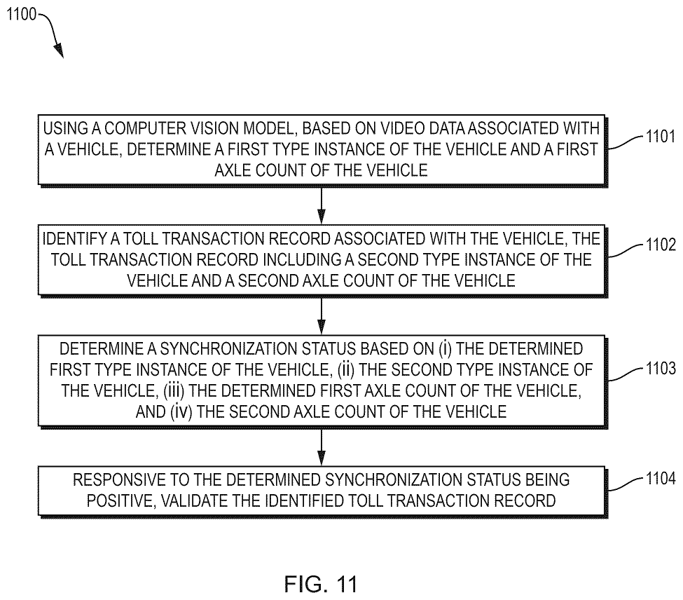

FIG. 11 is a flowchart of a method 1100 for intelligent toll validation according to an example embodiment. The method 1100 is computer-implemented and may be implemented using any computing device, e.g., a processor, or combination of computing devices known to those of skill in the art.

The method 1100 begins at step 1101 by, using a computer vision model (e.g., 170 (FIG. 1) or 970 (FIG. 9)), based on video data (e.g., 158 (FIG. 1), 858 (FIG. 8), or 958 (FIG. 9)), associated with a vehicle (e.g., 174 (FIG. 1)), to determine a first type instance (e.g., 134a (FIG. 1), 634a (FIG. 6), or 734a (FIG. 7)) of the vehicle and a first axle count (e.g., 136a (FIG. 1), 636a (FIG. 6), or 736a (FIG. 7)) of the vehicle. Next, at step 1102, the method 1100 identifies a toll transaction record (e.g., 126 (FIG. 1), 626 (FIG. 6), or 726 (FIG. 7)) associated with the vehicle. The toll transaction record including a second type instance (e.g., 134b (FIG. 1), 634b (FIG. 6), or 734b (FIG. 7)) of the vehicle and a second axle count (e.g., 136b (FIG. 1), 636b (FIG. 6), or 736b (FIG. 7)) of the vehicle. In turn, at step 1103, the method 1100 determines a synchronization status (e.g., 754 (FIG. 7)) based on (i) the determined first type instance of the vehicle, (ii) the second type instance of the vehicle, (iii) the determined first axle count of the vehicle, and (iv) the second axle count of the vehicle. At step 1104, responsive to the determined synchronization status being positive, the method 1100 then validates the identified toll transaction record.

As noted, the method 1100 is computer-implemented and, as such, the functionality and effective operations, e.g., the determining (1101, 1103), identifying (1102), and validating (1104), are automatically implemented by one or more digital processors. The method 1100 can also be implemented using any computer device or combination of computing devices known in the art. Among other examples, the method 1100 can be implemented using a computer 1200 described hereinbelow in relation to FIG. 12.

### Computer Support

FIG. 12 is a block diagram of an example embodiment of an internal structure of a computer 1200 in which various embodiments of the present disclosure may be implemented. The computer 1200 contains a system bus 1252, where a bus is a set of hardware lines used for data transfer among the components of a computer or digital processing system. The system bus 1252 is essentially a shared conduit that connects different elements of a computer system (e.g., processor, disk storage, memory, input/output (I/O) ports, network ports, etc.) that enables the transfer of information between the elements. Coupled to the system bus 1252 is an I/O device interface 1254 for connecting various input and output devices (e.g., keyboard, mouse, displays, printers, speakers, etc.) to the computer 1200. Network interface 1256 allows the computer 1200 to connect to various other devices attached to a network (e.g., global computer network, wide area network, local area network, etc.). Memory 1258 provides volatile or non-volatile storage for computer software instructions 1260 and data 1262 that may be used to implement embodiments of the present disclosure, where the volatile and non-volatile memories are examples of non-transitory media. Disk storage 1264 provides non-volatile storage for the computer software instructions 1260 and data 1262. A central processor unit (CPU) 1266 is also coupled to the system bus 1252 and provides for the execution of computer instructions, e.g., the instructions 1260.

As used herein, the terms “model,” “architecture,” “application,” and “tool” may refer to any hardware, software, firmware, electronic control component, processing logic, and/or processor device, individually or in any combination, including without limitation: an application specific integrated circuit (ASIC), a field-programmable gate array (FPGA), an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 12, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system for intelligent toll validation, the computer-based system comprising:
a computer vision model;
at least one processor; and
a memory with computer code instructions stored thereon, the at least one processor and the memory, with the computer code instructions, being configured to cause the computer-based system to:
using the computer vision model, based on video data associated with a vehicle, determine a first type instance of the vehicle and a first axle count of the vehicle;
identify a toll transaction record associated with the vehicle, the toll transaction record including a second type instance of the vehicle and a second axle count of the vehicle;
determine a synchronization status based on (i) the determined first type instance of the vehicle, (ii) the second type instance of the vehicle, (iii) the determined first axle count of the vehicle, and (iv) the second axle count of the vehicle; and
responsive to the determined synchronization status being positive, validate the identified toll transaction record.

2. The computer-based system of claim 1, wherein the at least one processor and the memory, with the computer code instructions, are further configured to cause the computer-based system to:
responsive to the determined synchronization status being negative, using the computer vision model, based on the video data, determine a revised type of the vehicle.

3. The computer-based system of claim 1, wherein the computer vision model is configured to determine the first type instance of the vehicle and the first axle count of the vehicle based on a shape of the vehicle.

4. The computer-based system of claim 1, wherein the at least one processor and the memory, with the computer code instructions, are further configured to cause the computer-based system to:
using the computer vision model, based on the video data, detect the vehicle.

5. The computer-based system of claim 1, wherein the at least one processor and the memory, with the computer code instructions, are further configured to cause the computer-based system to:
using the computer vision model, based on the video data, track the vehicle.

6. The computer-based system of claim 5, wherein the at least one processor and the memory, with the computer code instructions, are further configured to cause the computer-based system to:
using the computer vision model, based on the video data, assign a tracking identifier (ID) to the vehicle.

7. The computer-based system of claim 1, wherein the determined first type instance of the vehicle is a car type, a truck type, or a bus type.

8. The computer-based system of claim 7, wherein the determined first type instance of the vehicle is the truck type, and wherein the determined first axle count of the vehicle is two, three, four, five, six, seven, or greater than seven.

9. The computer-based system of claim 7, wherein the determined first type instance of the vehicle is the truck type, and wherein the at least one processor and the memory, with the computer code instructions, are further configured to cause the computer-based system to:
using the computer vision model, based on the video data, determine a unit type of the vehicle.

10. The computer-based system of claim 9, wherein the determined unit type includes a trailer count.

11. The computer-based system of claim 1, wherein each of the determined first type instance of the vehicle and the second type instance of the vehicle is a Federal Highway Administration (FHWA) vehicle category classification.

12. The computer-based system of claim 1, wherein the at least one processor and the memory, with the computer code instructions, are further configured to cause the computer-based system to:
using the computer vision model, based on the video data, determine a body style of the vehicle.

13. The computer-based system of claim 1, wherein the at least one processor and the memory, with the computer code instructions, are further configured to cause the computer-based system to:
store the validated toll transaction record in a database.

14. The computer-based system of claim 1, wherein the at least one processor and the memory, with the computer code instructions, are further configured to cause the computer-based system to:
using the computer vision model, based on the video data, determine (i) that the vehicle is stopped or (ii) a direction of travel of the vehicle.

15. The computer-based system of claim 1, wherein the at least one processor and the memory, with the computer code instructions, are further configured to cause the computer-based system to:
using the computer vision model, based on the video data, determine at least one of (i) a lane change count of the vehicle and (ii) a lane change frequency of the vehicle.

16. The computer-based system of claim 1, wherein the at least one processor and the memory, with the computer code instructions, are further configured to cause the computer-based system to:
using the computer vision model, based on the video data, determine a traffic congestion status.

17. The computer-based system of claim 1, wherein the at least one processor and the memory, with the computer code instructions, are further configured to cause the computer-based system to:
using the computer vision model, based on the video data, identify a presence of at least one of (i) a non-vehicle transportation device and (ii) a pedestrian.

18. The computer-based system of claim 1, wherein the at least one processor and the memory, with the computer code instructions, are further configured to cause the computer-based system to:
using the computer vision model, based on the video data, determine whether the vehicle is located in a predefined area.

19. The computer-based system of claim 1, wherein the vehicle is travelling in a lane at a first time point, wherein the toll transaction record further includes a second time point and a second ID of the lane, and wherein the at least one processor and the memory, with the computer code instructions, are further configured to cause the computer-based system to:
identify the toll transaction record based on (i) the first time point, (ii) a first ID of the lane, (iii) the second time point, and (iv) the second ID of the lane.

20. A computer-implemented method for intelligent toll validation, the computer-implemented method comprising:
using a computer vision model, based on video data associated with a vehicle, determining a first type instance of the vehicle and a first axle count of the vehicle;
identifying a toll transaction record associated with the vehicle, the toll transaction record including a second type instance of the vehicle and a second axle count of the vehicle;
determining a synchronization status based on (i) the determined first type instance of the vehicle, (ii) the second type instance of the vehicle, (iii) the determined first axle count of the vehicle, and (iv) the second axle count of the vehicle; and
responsive to the determined synchronization status being positive, validating the identified toll transaction record.

21. A non-transitory computer program product for intelligent toll validation, the non-transitory computer program product comprising a computer-readable medium with computer code instructions stored thereon, the computer code instructions being configured, when executed by at least one processor, to cause the at least one processor to:
using a computer vision model, based on video data associated with a vehicle, determine a first type instance of the vehicle and a first axle count of the vehicle;
identify a toll transaction record associated with the vehicle, the toll transaction record including a second type instance of the vehicle and a second axle count of the vehicle;
determine a synchronization status based on (i) the determined first type instance of the vehicle, (ii) the second type instance of the vehicle, (iii) the determined first axle count of the vehicle, and (iv) the second axle count of the vehicle; and
responsive to the determined synchronization status being positive, validate the identified toll transaction record.
